(19) United States
(12) Patent Application Publication
(10) Pub. No.: US 2024/0011786 A1
(43) Pub. Date: Jan. 11, 2024

(54) METHOD AND SYSTEM OF PREDICTIVE POSITIONING

(71) Applicant: Compathnion Technology Limited, Hong Kong (HK)

(72) Inventor: Ngoc Linh TA, Hong Kong (HK)

(21) Appl. No.: 17/858,086

(22) Filed: Jul. 6, 2022

(51) Int. Cl. G01C 21/36

(52) U.S. Cl. CPC G01C 21/3617

(57) ABSTRACT

The present invention discloses a method and system of predictive positioning. In an embodiment of a method of predictive positioning, the method comprises the steps of obtaining geographic information data of a target area; registering a reference point within said target area; retrieving reference point data of said reference point; calculating a displacement from said reference point based on readings obtained from a set of sensors, said readings comprising orientation, acceleration and angular acceleration; and combining said reference point data of said reference point and said displacement from said reference point to determine a heuristic location. The present invention makes use of sensors in a user device to predict the position and removes the need of beacons, hence no installation and maintenance are necessary.

### FIELD OF INVENTION

The present invention is related to a positioning method and system, in particular related to a method and system of predictive positioning using sensors.

### BACKGROUND OF INVENTION

There has been a need for positioning activities across different fields and industries, for example navigation to shops or other points of interests in malls, for finding nearest support in smart hospitals or construction sites, or locating a certain product aisle within a store such as a supermarket. Prior solutions have drawbacks in terms of cost, deployment process and limitation by operating systems. For example, a Bluetooth beacon-based positioning system requires multiple beacons placed throughout the area, which leads to a higher maintenance cost. Conventional positioning systems also rely on change in signal strength to estimate the position, and malfunction of a single beacon may hugely affect the accuracy of the whole system.

### SUMMARY OF INVENTION

In forelight of the above background, the present invention provides a method and system of predictive positioning. The method and system of the present method uses sensors to calculate a displacement from a reference point to determine a heuristic location. The sensors are readily found in a user device such as a smart phone, so no extra deployment and maintenance costs are needed, while providing a high level of accuracy in crowded areas.

In a first embodiment of a method of predictive positioning, the method comprises the steps of obtaining geographic information data of a target area; registering a reference point within said target area; retrieving reference point data of said reference point; calculating a displacement from said reference point based on readings obtained from a set of sensors, said readings comprising orientation, acceleration and angular acceleration; and combining said reference point data of said reference point and said displacement from said reference point to determine a heuristic location.

In one embodiment, the method further comprises the steps of: periodically updating said reference point; comparing a score of an updated reference point to said heuristic location based on accuracy and a time stamp; and setting a location with a higher score to be a final location.

In another embodiment, said geographic information data of said target area includes walkable paths and non-walkable paths, said method further comprising the steps of: checking whether said determined heuristic location is within non-walkable paths; adjusting said heuristic location to be within walkable paths if said heuristic location is within non-walkable paths.

In a preferred embodiment, said displacement is converted to a set of offset values to be combined with said reference point data to determine said heuristic location.

A system of predictive positioning of the present invention comprises: a geographic information system module for obtaining geographic information system data of a target area; a reference point updater module for registering a reference point within said target area and retrieving reference point data of said reference point; a set of sensors for measuring sensor readings including orientation, acceleration and angular acceleration; a heuristic updater module connected to said geographic information system module, said reference point updating module and said set of sensors; said heuristic updater receives said geographic information system data of said target area from said geographic information system module, receives said reference point data from said reference point updater module, receives said sensor readings from said set of sensors, calculates a displacement from said sensor readings, and combines said reference point data and said displacement to determine a heuristic location within said target area.

The method and system of the present invention uses a reference point obtained using GPS or other methods as a starting location. A displacement is calculated from the set of sensors and added to the starting location to determine a heuristic location. The present invention only needs a user device which has the necessary sensors, which is commonly found in a smart phone or a tablet. Beacons are not needed and therefore no installation and maintenance are needed. The sensors allow the location to be updated between reference point updates and therefore provides a more accurate location at most times. This present invention is especially useful in crowded indoor areas where signals may be constantly interfered or interrupted.

### BRIEF DESCRIPTION OF DRAWINGS

FIG. 1 shows a procedural flow chart of a method of predictive positioning according to an embodiment of the present invention.

FIG. 2 shows a block diagram and data flow of a system of predictive positioning according to an embodiment of the present invention.

FIG. 3 shows a sample display on a user device with a map application utilizing the method of predictive positioning according to an embodiment of the present invention..

### DETAILED DESCRIPTION OF INVENTION

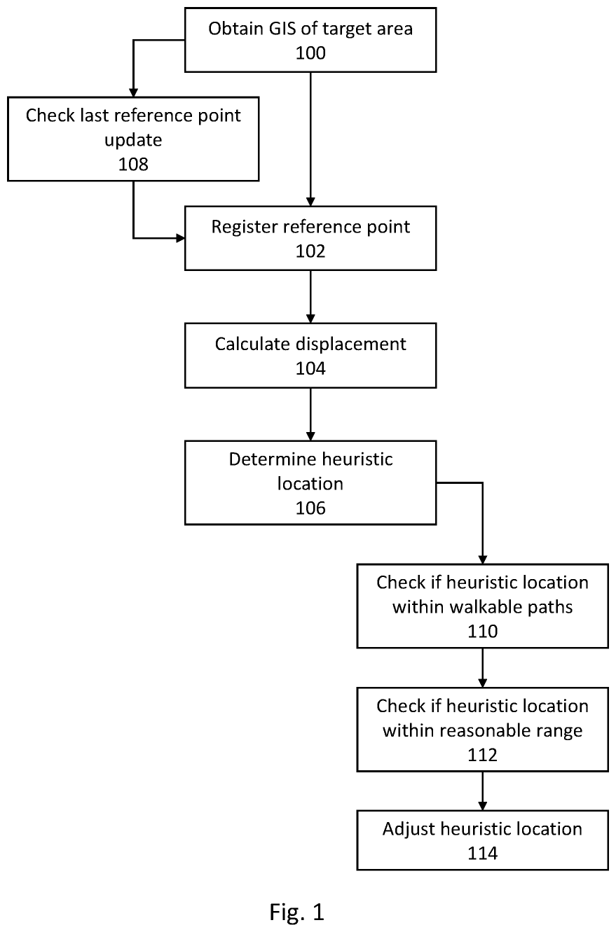

A method of predictive positioning is shown in FIG. 1 according to a first embodiment of the present invention. In step 100, geographical information system (GIS) data of a target area is obtained by a user device. In one embodiment, the target area is an area within a predetermined distance from a center point, which for example is a current location of the user device. The area can be continually updated as the user device moves to another location. In another embodiment, the target area is a predetermined fixed area and can be pre-obtained while the user device is not within the target area. In an embodiment, the GIS data include GeoPoint information for outdoor areas which comprises longitude and latitude information, or GeoJson information for indoor spaces, which can comprise walking paths, walls, rooms or spaces which are defined by polygons with latitude and longitude information etc. The GIS data can be obtained by retrieving from another application such as map application, downloading from a trusted source at regular intervals, or downloading a file containing GIS data of a predetermined fixed area.

In step 102, a reference point within the target area is registered as a starting point of the calculation. In one embodiment, the reference point is a most recent location of the user device obtained from a sufficiently accurate positioning technology, including but not limited to GPS, Wi-Fi, geomagnetic, BLE, UWB etc. In an alternate embodiment, the reference point is registered when the user device interacts with a specific item at a specific location, for example a readable code displayed at signage board at an entrance of a venue or a building. A reference point data of the reference point includes at least a longitude, a latitude, a time stamp, an accuracy (in ordinal of accuracy level e.g. “high”, “low”), and optionally speed, speed accuracy, and altitude etc., which are in general provided in normalized GIS format. The reference point data of the reference point is retrieved by the user device for the steps below.

In step 104, a displacement of the user device from the reference point is calculated based on readings obtained from a set of sensors. The set of sensors include at least one of a gyroscope, a compass, an accelerator, or a pedometer. In a preferred embodiment, the user device is a smart phone which inherently includes all of the above sensors such that no externally connected sensors are required. The set of sensors measures the current orientation and also angular and acceleration data of the user device such that the displacement of the user device within a time period can be calculated. In one embodiment, an acceleration pattern of the user device is also analyzed and associated to a walking pattern of a user, which allows a number of steps and an average displacement of a step to be determined and used in the calculation of displacement. In a preferred embodiment, the sensor readings are measured in metric units, as such the displacement is first calculated in metric scale units and then converted into a set of offset values including a longitude offset, a latitude offset and optionally an altitude offset value. The time stamp of each reading taken by the sensors are also recorded as they are needed for determining the time period that displacement is to be calculated.

In step 106, the GIS data of the reference point and the offset values based on the displacement calculated from sensor readings are combined to determine a heuristic location. The heuristic location is returned as a final location in GeoPoint format and can be used by other applications, for example a map application.

In a preferred embodiment, the user device attempts to periodically update the reference point at regular intervals. In step 108, the user device checks the time of last successful update of reference point, and the last detected reference point is registered when the reference point fails to be updated in a predetermined time period or for a predetermined number of attempts. In a further embodiment, the reference point continues to be periodically updated while the predictive positioning algorithm is in process. The reference point can be determined to be updated or not based on a score depending on the accuracy and the time stamp of the reference point. When the reference point is updated, the displacement is reset and recalculated starting from the time stamp of the update. In an embodiment, the updated reference point is compared to the heuristic location determined using the previous reference point, and the one with a higher score based on accuracy and time stamp will be returned as the final location.

In a preferred embodiment, in step 110 the method further comprises the step of checking whether the heuristic location is within walkable paths and within reasonable walking range. The GIS data of the target area includes information on whether a certain location or area is within walkable paths or non-walkable paths, for example walls or pillars is considered outside walkable paths. A reasonable walking range can be a fixed threshold value that is compared to the calculated displacement. If the heuristic location as calculated from the displacement is outside walkable paths or outside reasonable walking range, in step 112 the heuristic location is adjusted such that the adjusted heuristic location returned in GeoPoint format is within walkable paths and reasonable walking range to be used by other applications. For example, the adjusted heuristic location may be a location within walkable paths having a smallest displacement to the calculated location which is outside walkable paths, or the adjusted heuristic location may be a location where some of the readings are disregarded in the calculation, for example in situations where certain readings are found to be extremely out of range.

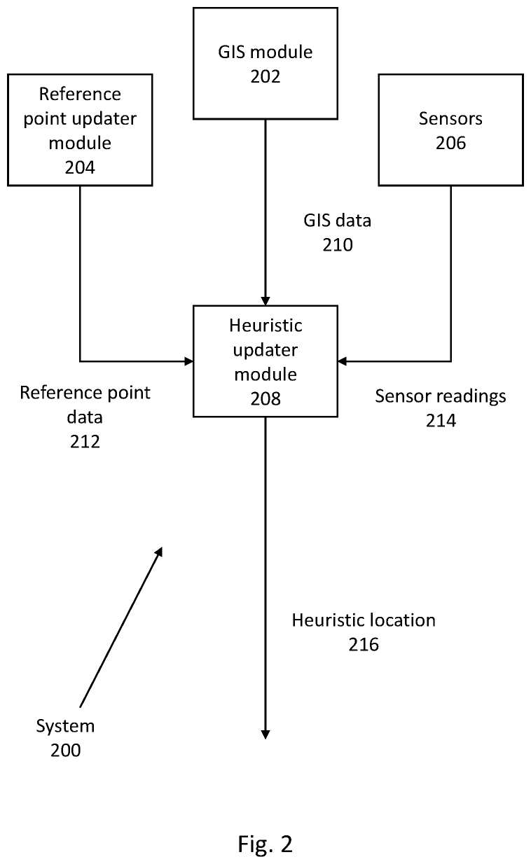

FIG. 2 shows a block and data flow diagram of a system of predictive positioning according to an embodiment of the present invention. The system 200 comprises a GIS module 202 for obtaining GIS data of a target area, a reference point updater module 204 for periodically updating the reference point, and a set of sensors 206 including at least a gyroscope, a compass and an accelerator for obtaining hardware sensor readings such as orientation, angular and acceleration information of the user device. A heuristic updater module 208 for determining the final location is connected to all three above modules. GIS data 210 of the target area is sent from the GIS module 202 to the heuristic updater module 208, reference point data 212 comprising GeoPoint information of the reference point and time stamp of the reference point is sent from the reference point updater 204 to the heuristic updater module 208, and the sensor readings 214 which also includes time stamps of each reading taken are sent from the set of sensors 206 to the heuristic updater module 208. The heuristic updater module 208 receives the GeoPoint information of the reference point, calculates a displacement and in turn a set of offset values based on the sensor readings 214, and combines the offset values with the reference point location to determine a heuristic location 216. The heuristic location 216 is then returned as the current GeoPoint information to be used in other applications. In a preferred embodiment, the system 200 is provided in a user device such as a smart phone or a tablet with a display, which allows an external map application to display the final location.

In one embodiment, areas outside walkable paths are filtered from the GIS data 210 before the heuristic location 216 is determined. The filtering can be performed by the GIS module 202 before sending the GIS data 210 to the heuristic updater module 208, or can be performed by the heuristic updater module 208. In another embodiment, the heuristic updater module 208 checks whether the displacement calculated from the sensor readings 214 is within a threshold value which for example is a reasonable walking range. The heuristic updater module 208 then uses the last valid value or disregards the extreme values to ensure the heuristic location 216 is within reasonable walking range and within walkable paths.

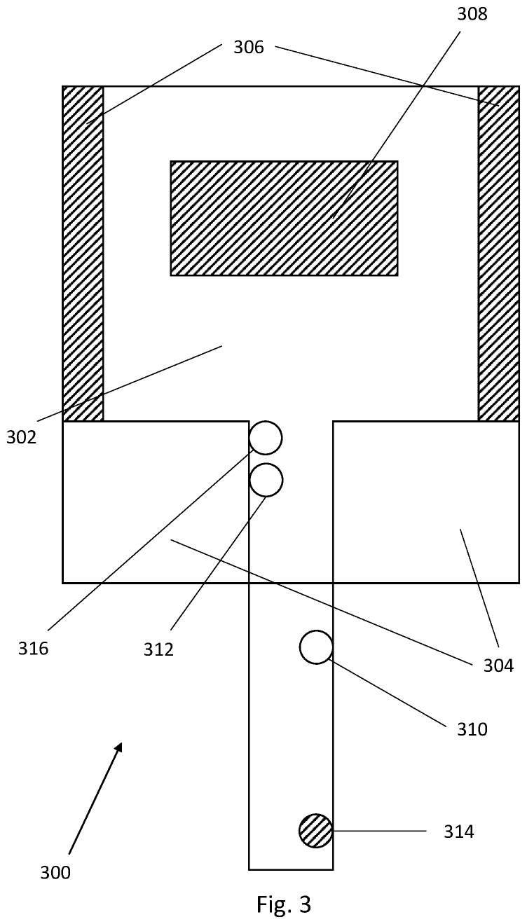

FIG. 3 shows an example of a display of a user device utilizing the heuristic positioning method and system according to an embodiment of the present invention. A map 300 of a target area is displayed based on GIS data of the target area. In this example an indoor area is displayed for illustration purposes. The map 300 comprises paths 302, rooms 304, walls 306 and empty spaces 308. Paths 302 and rooms 304 are regarded as walkable paths, while walls 306 and empty spaces 308 are regarded as outside walkable paths and is shaded in the figure for clarity. A reference point 310 is registered which in this example is a fixed location at an entrance of the indoor area. A heuristic location 312 is determined and displayed where displacement calculated from sensor readings is combined with the coordinates of the reference point 310. Expired location 314 is a previously registered reference point that is replaced by a reference point having a higher score based on accuracy and time stamp. Real location 316 shows the actual location of the user device, which illustrates that heuristic location 312 is significantly closer to the real location 316 than the reference point 310. For illustration purposes, only the current floor of the indoor area is shown, but as the altitude of the user device changes, a different floor may be displayed.

Below shows two pseudo-code sections explaining the method of the present invention.

```
    Pseudo-code section 1:
    referenceGeo ← { }
heuristicGeo ← { }
foreach referenceGeos RGk of venue dataset:
  ReferenceGeo ← Nil
  if RGk {Accuracy, Timestamp} >
  referenceGeo{Accuracy, Timestamp}:
    referenceGeo = RGK
if heuristicGeo{Accuracy, Timestamp} >
referenceGeo{Accuracy, Timestamp}:
  gisWalkablePaths = GIS.filter(walkway)
heuristicGeo = heuristicNextGeo(heuristicGeo, sensor,gisWalkablePaths);
return heuristicGeo
```

This pseudo-code section shows that the reference point obtained from multiple sources are compared and the one with the highest score is chosen. heuristicGeo stores the latest heuristic location, and if the heuristic location has a higher score than the reference point, the heuristic location is then set as the final location. This process continues until the reference point is updated such that the score of the reference point is higher than the heuristic location, and then it will start over again. It also shows that non-walkable paths are filtered before calculating the heuristic location.

```
    Pseudo-code section 2:
    Function heuristicNextGeo(heuristicGeo, sensor,gisWalkablePaths):
  walkingOrientation ← sensor.orientation
  walkingSpeed ← sensor.accelations
  newHeuristicGeo = heuristicGeo +
  displacementFrom(walkingOrientation, walkingSpeed)
  if newHeuristicGeo outside gisWalkablePaths:
newHeuristicGeo = regressionOnWalkablePaths(newHeuristicGeo)
  Return newHeuristicGeo;
```

This pseudo-code section shows that the displacement is calculated by combining the last heuristic location with the displacement calculated based on sensor orientation and sensor acceleration readings. A check of whether the new heuristic location is outside walking paths is performed, and the new heuristic location is adjusted by regressing on walkable paths. The new heuristic location will then be returned.

The embodiments of the present invention are all disclosed above. One skilled in the art should understand that the embodiments are shown as examples but not limitations, and variations can be made to the details without departing from the concept of the invention. The scope of protection of the invention shall be defined by the claims but not the specification.

What is claimed is:

1. A method of predictive positioning, comprising the steps of:
obtaining geographic information data of a target area;
registering a reference point within said target area;
retrieving reference point data of said reference point;
calculating a displacement from said reference point based on readings obtained from a set of sensors, said readings comprising orientation, acceleration and angular acceleration; and
combining said reference point data of said reference point and said displacement from said reference point to determine a heuristic location.

2. The method of predictive positioning of claim 1, further comprising the steps of:
periodically updating said reference point;
comparing a score of an updated reference point to said heuristic location based on accuracy and a time stamp; and
setting a location with a higher score to be a final location.

3. The method of predictive positioning of claim 1, wherein said step of registering said reference point is performed when said reference point fails to be updated in a predetermined period of time.

4. The method of predictive positioning of claim 1, wherein said geographic information data of said target area includes walkable paths and non-walkable paths, said method further comprising the steps of:
checking whether said determined heuristic location is within non-walkable paths;
adjusting said heuristic location to be within walkable paths if said heuristic location is within non-walkable paths.

5. The method of predictive positioning of claim 1, wherein a walking pattern is analyzed based on acceleration readings obtained from said set of sensors, and a number of steps and a walking speed are determined based on said walking pattern for calculating said displacement.

6. The method of predictive positioning of claim 1, wherein said displacement is converted to a set of offset values to be combined with said reference point data to determine said heuristic location.

7. A system of predictive positioning, comprising:
a geographic information system module for obtaining geographic information system data of a target area;
a reference point updater module for registering a reference point within said target area and retrieving reference point data of said reference point;
a set of sensors for measuring sensor readings including orientation, acceleration and angular acceleration;
a heuristic updater module connected to said geographic information system module, said reference point updating module and said set of sensors; said heuristic updater receives said geographic information system data of said target area from said geographic information system module, receives said reference point data from said reference point updater module, receives said sensor readings from said set of sensors, calculates a displacement from said sensor readings, and combines said reference point data and said displacement to determine a heuristic location within said target area.

8. The system of predictive positioning according to claim 7, wherein said reference point updating module registers said reference point if said reference point fails to be updated for a predetermined period of time.

9. The system of predictive positioning of claim 7, wherein said geographic information system data includes walkable paths and non-walkable paths, said heuristic updater module checks whether said heuristic location is within walkable paths, and adjusts said heuristic location if said heuristic location is outside walkable paths.

10. The system of predictive positioning of claim 7, wherein said calculated displacement is converted to a set of offset values including a latitude offset and a longitude offset to be combined with said reference point data to determine said heuristic location.
